(19) United States
(12) Patent Application Publication
(10) Pub. No.: US 2011/0117977 A1
(43) Pub. Date: May 19, 2011

(54) MOBILE TERMINAL

(75) Inventors: Naoyuki Yamashita, Tokyo (JP); Yasushi Komine, Tokyo (JP); Satoru Noma, Tokyo (JP)

(73) Assignee: KABUSHIKI KAISHA TOSHIBA, TOKYO (JP)

(21) Appl. No.: 12/878,058

(22) Filed: Sep. 9, 2010

(30) Foreign Application Priority Data
Nov. 17, 2009 (JP) P2009-261523

(51) Int. Cl. H04M 1/00

(52) U.S. Cl. 455/575.4

(57) ABSTRACT

According to one embodiment, a mobile terminal has a first housing, a second housing disposed on the first housing, a rail plate, a sliding plate, and a resilient member. The rail plate has a pair of rails and a base connecting the rails and formed an opening. The rail plate is fixed to a surface of the second housing facing the first housing. The sliding plate is fixed to a surface of the first housing facing the second housing and slides on the rails. The resilient member is disposed between the second housing and the sliding plate. The resilient member is connected to the sliding plate at one end and to the second housing through the opening at the other end.

### CROSS-REFERENCE TO RELATED APPLICATION

This application is based upon and claims the benefit of priority from Japanese Patent Application No. 2009-261523, filed Nov. 17, 2009; the entire contents of which are incorporated herein by reference.

### FIELD

Embodiments relate to a mobile terminal.

### BACKGROUND

Some recent mobile terminals have an upper housing with a display capable of sliding with respect to a lower housing with an operation key. A mobile terminal of this type has a slider mechanism that enables sliding operation of the housings (see JP2009-153221A (Patent Document 1), for example).

The slider mechanism disclosed in Patent Document 1 is composed of a plurality of members including a base plate, a sliding plate that slides on the base plate, and a wire that exerts a restoring force on the sliding plate. In an open state of the mobile terminal, the operation key and the display are usable, and in a closed state thereof, only the display is usable. The mobile terminal with the slider mechanism can be opened and closed by a simple sliding operation.

However, since the slider mechanism includes a plurality of members as described above, mobile terminals of this type tend to be thicker than folding mobile terminals or bar-type mobile terminals.

In addition, the slider mechanism is disposed on the lower housing so as to face the sliding surface of the upper housing and the operation key which are seen by the user when the mobile terminal is in the open state. In order to prevent the slider mechanism from scratching the sliding surface or the operation key during sliding, it is required for the mobile terminal to be formed with a certain clearance between the slider mechanism and the upper housing and between the slider mechanism and the operation key. The provision of such clearance hinders reduction of the thickness of the sliding mobile terminal.

### BRIEF DESCRIPTION OF THE DRAWINGS

In the accompanying drawings:

FIG. 1 is a perspective view showing an appearance of a slide type mobile terminal closed;

FIG. 2 is a perspective view showing an appearance of a front side of a slide type mobile terminal opened;

FIG. 3 is a perspective view showing an appearance of a back side of a slide type mobile terminal opened;

FIG. 4 is an exploded perspective view of a mobile terminal according to a first embodiment;

FIG. 5 is a perspective view of a slide mechanism of a mobile terminal in the closed state;

FIG. 6 is a perspective view of a slide mechanism of a mobile terminal in the open state;

FIG. 7 is a cross-sectional view of a mobile terminal taken along the line VII-VII in FIG. 3;

FIG. 8 is an enlarged view of a part indicated by an arrow VIII in FIG. 7;

FIG. 9 is a perspective view of a slide mechanism according to a comparative example for comparison with that of FIG. 5;

FIG. 10 is a perspective view of a slide mechanism for comparison with that of FIG. 6;

FIG. 11 is an enlarged cross-sectional view of a slide mechanism for comparison with that of FIG. 8;

FIG. 12 is an exploded perspective view of a mobile terminal according to a second embodiment;

FIG. 13 is a perspective view of a slider mechanism of a mobile terminal in a closed state;

FIG. 14 is a perspective view of a slider mechanism of a mobile terminal in an open state;

FIG. 15 is a cross-sectional view of a mobile terminal taken along the line XV-XV in FIG. 3;

FIG. 16 is an enlarged view of a part of a mobile terminal indicated by an arrow XVI in FIG. 15; and

FIG. 17 is an enlarged cross-sectional view of a mobile terminal according to a modification of the second embodiment.

### DETAILED DESCRIPTION

Embodiments of the present invention have been made in consideration of the circumstances mentioned above and an object thereof is to provide a mobile terminal capable of reducing of the thickness of a housing thereof.

To achieve the above object, a mobile terminal according to the embodiments include: a first housing, a second housing disposed on the first housing, a rail plate, a sliding plate, and a resilient member. The rail plate has a pair of rails and a base connecting the rails and is formed with an opening. The rail plate is fixed to a surface of the second housing facing the first housing. The sliding plate is fixed to a surface of the first housing facing the second housing and slides on the rails. The resilient member is disposed between the second housing and the sliding plate. The resilient member forces the sliding plate in a first direction opposite to a second direction until the sliding plate reaches a predetermined position. The resilient member forces the sliding plate in the second direction once the sliding plate passes the predetermined position when the sliding plate slides in the second direction. The resilient member is connected to the sliding plate at one end and to the second housing through the opening at the other end.

### First Embodiment

A mobile terminal according to a first embodiment of the present invention will be described hereunder with reference to the drawings.

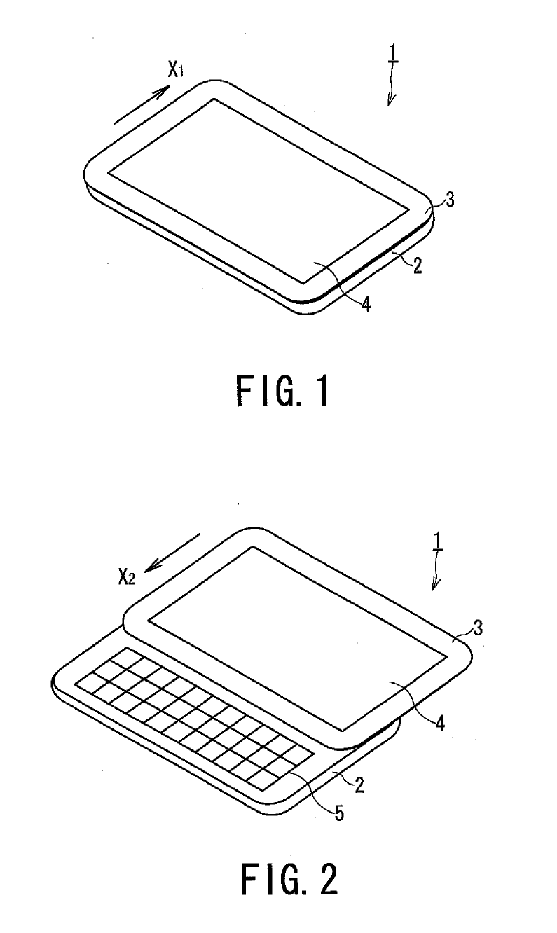

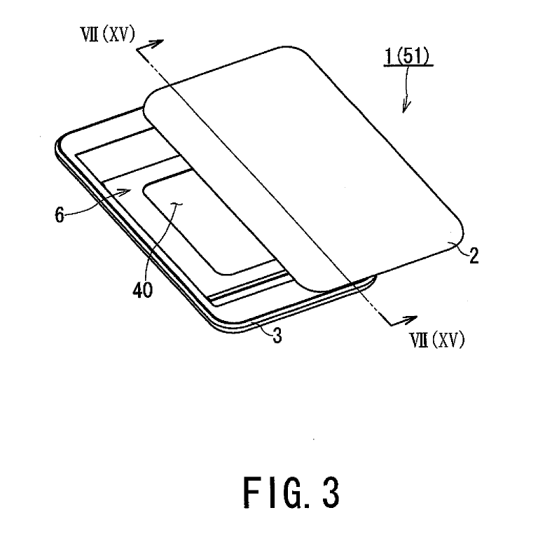

FIGS. 1 to 3 are perspective views showing appearances of a slide type mobile terminal 1, which is an example of a mobile terminal according to the present invention. FIG. 1 is a perspective view showing an appearance of the slide type mobile terminal 1 closed (in a closed state). FIG. 2 is a perspective view showing an appearance of the front side of a slide type mobile terminal 1 opened (in an open state). FIG. 3 is a perspective view showing an appearance of the back side of the slide type mobile terminal 1 opened (in the open state).

The mobile terminal 1 has a lower housing 2 as a first housing and an upper housing 3 as a second housing disposed on the lower housing 2.

The display 4 covers a large portion (area) of a front surface of the upper housing 3. A surface of the mobile terminal 1 on which the display 4 is provided is referred to as a front surface of the mobile terminal 1. The opposite surface is referred to as a back surface of the mobile terminal 1. The display 4 may be a liquid crystal display (LCD), an organic electroluminescence (EL) display, or an inorganic EL display, for example.

The lower housing 2 has an operation key 5. The operation key 5 is usable when the mobile terminal 1 is in the open state.

A slide mechanism 6 (see FIG. 3) allows the upper housing 3 and the lower housing 2 to slide with respect to each other in directions indicated by the arrows X1 and X2 (see FIGS. 1 and 2). More specifically, when the mobile terminal 1 is in the closed state as shown in FIG. 1, the upper housing 3 can be slid in the X1 direction to open the mobile terminal 1 as shown in FIG. 2. On the other hand, when the mobile terminal 1 is in the open state as shown in FIG. 2, the upper housing 3 can be slide in the X2 direction to close the mobile terminal 1 as shown in FIG. 1.

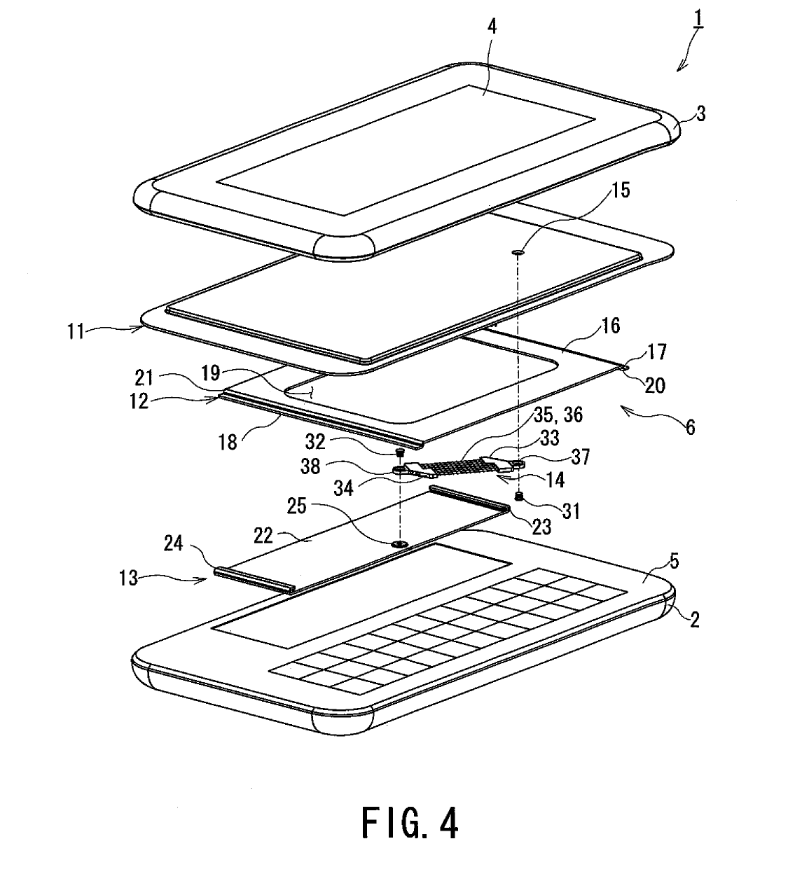

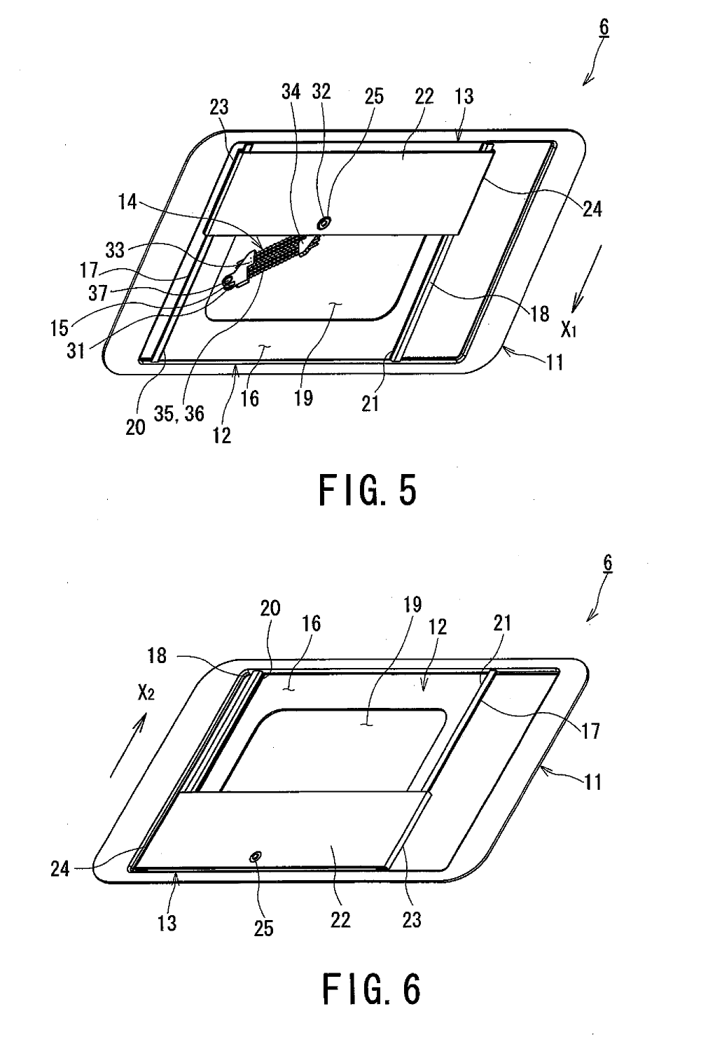

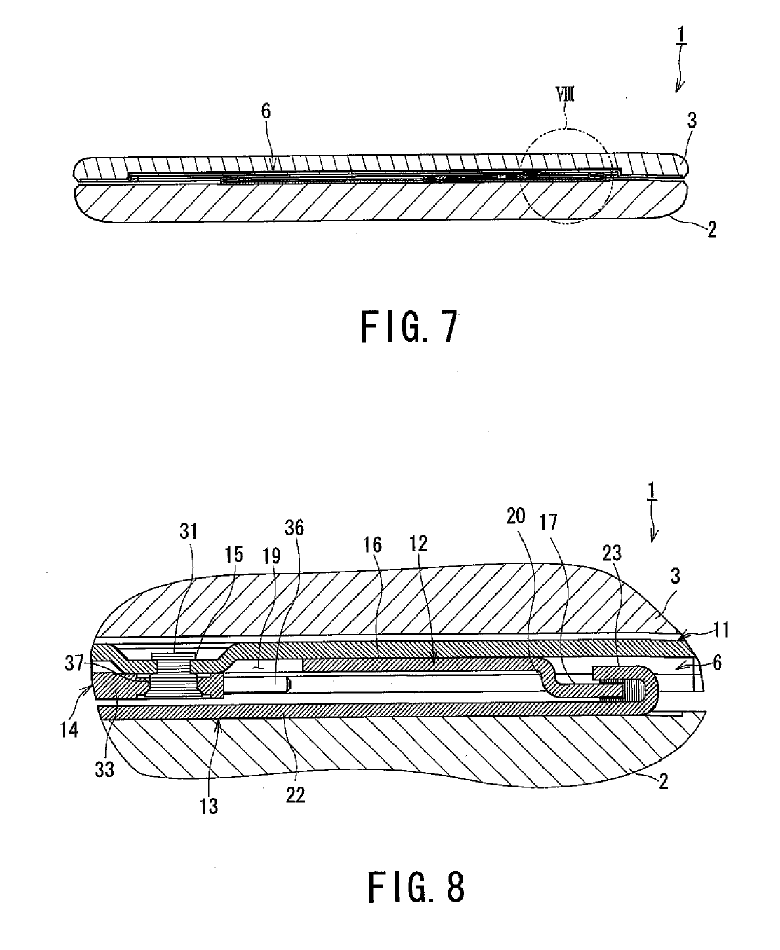

FIG. 4 is an exploded perspective view of the mobile terminal 1 according to the first embodiment. FIG. 5 is a perspective view of the slide mechanism 6 of the mobile terminal 1 in the closed state. FIG. 6 is a perspective view of the slide mechanism 6 of the mobile terminal 1 in the open state. FIG. 7 is a cross-sectional view of the mobile terminal 1 taken along a line VII-VII in FIG. 3. FIG. 8 is an enlarged view of a part indicated by an arrow VIII in FIG. 7.

As shown in FIG. 4, the slide mechanism 6 basically has a base plate 11, a rail plate 12, a sliding plate 13, and a resilient member 14.

The base plate 11 is disposed on a surface of the upper housing 3 opposite to the surface on which the display 4 is provided. In the open state, a part of the base plate 11 is exposed to serve as an exterior of the upper housing 3 at the back of the mobile terminal 1 when the mobile terminal is in the open state. The base plate 11 has an attachment hole 15 through which an attachment pin 31 is inserted to attach the resilient member 14 to the base plate 11. As shown in FIG. 8, the part of the base plate 11 where the attachment hole 15 is formed is slightly lower than the other part. This is because of preventing the resilient member 14 attached to the base plate 11 from coming into contact with and scratching the surface of the base plate 11 other than the part of the attachment hole 15.

The base plate 11 may be formed integrally with the upper housing 3. That is, the base plate 11 may not be a part of the slide mechanism 6, but a part of the upper housing 3 may serve as the base plate 11. Thus, the following description includes the case where a part of the upper housing 3 serves as the base plate 11.

As shown in FIG. 4, the rail plate 12 has rails 17 and 18, and a base 16. The rail plate 12 may be welded or otherwise fixed to the surface of the base plate 11 facing the lower housing 2.

The rails 17 and 18 extend along the opposite shorter sides of the rail plate 12. The rails 17 and 18 are each positioned at levels slightly different from the base 16 because of formation of steps 20 and 21. Referring to FIG. 4, the rails 17 and 18 are lower than the base 16 because the steps 20 and 21 extend downwardly. The rails 17 and 18 constitute a pair of rails extending in the sliding direction of the housings 2 and 3.

The base 16 connects the rails 17 and 18 to each other. The base 16 is formed with an opening 19. The opening 19 is a substantially rectangular opening formed in the base 16.

The sliding plate 13 has a flat plate 22 and bent parts 23 and 24. The flat plate 22 has an attachment hole 25 through which an attachment pin 32 is inserted to attach the resilient member 14 to the flat plate 22. The bent parts 23 are formed at the opposite shorter sides of the flat plate 22. The bent parts 23 and 24 have a substantially U-shape in cross section. The bent parts 23 and 24 have shapes corresponding to the shapes of the rails 17 and 18 and slidably contact with the rails 17 and 18, respectively.

The base plate 11, the rail plate 12 and the sliding plate 13 may be molded from a metal plate by press working. The bent parts 23 and 24 are made of a resin material that is superior in strength, resiliency, impact resistance, sliding characteristics or the like, for example.

The resilient member 14 is attached to the sliding plate 13 and the base plate 11 and provides a restoring force thereof to the sliding plate 13. The resilient member 14 is provided with holders 33 and 34, a plurality of coil springs 35 and a plurality of wires 36 inserted into the coil springs 35. The plurality of coil springs 35 are held by the holders 33 and 34 at the opposite ends. When the sliding plates 13 slides, the coil springs 35 expand or shrink. The distance between the holders 33 and 34 increases or decreases, and the wires 36 retract into or protrude from the holders 33 and 34.

The holder 33 has a pin insertion hole 37 through which the attachment pin 31 is inserted to connect one end of the resilient member 14 to the base plate 11. The holder 34 has a pin insertion hole 38 through which the attachment pin 32 is inserted to connect the other end of the resilient member 14 to the sliding plate 13. The holders 33 and 34 can pivot about attachment pins 31 and 32 after connection to the base plate 11 and the sliding plate 13.

The resilient member 14 is connected to the sliding plate 13 at one end and to the base plate 11 through the opening 19 of the rail plate 12 at the other end. For example, when the mobile terminal 1 is closed as shown in FIG. 5, the resilient member 14 is housed in the opening 19 of the rail plate 12.

When the sliding plate 13 is in the closed state as shown in FIG. 5, the resilient member 14 forces the sliding plate 13 into a direction to keep the sliding plate 13 in the closed state. Specifically, the resilient member 14 forces the sliding plate 13 by the action of a component of the restoring force into the X2 direction (FIG. 6) opposite to the X1 direction. Once the sliding plate 13 starts sliding in the X1 direction, which is a first direction, the resilient member 14 keeps forcing the sliding plate 13 into the X2 direction until the sliding plate 13 reaches a predetermined position. The predetermined position corresponds to a position at which the component of the restoring force in the X2 direction becomes 0 (or in other words, only a component of the restoring force in a direction perpendicular to the X1 and X2 directions exists). A component of the restoring force in the X1 direction occurs when the sliding plate 13 passes the predetermined position. The restoring force of the resilient member 14 exerted on the sliding plate 13 changes direction as the resilient member 14 pivots about the attachment pins 31 and 32. After the sliding plate 13 passes the predetermined position, the resilient member 14 forces the sliding plate 13 into the X1 direction.

When the sliding plate 13 is in the open state as shown in FIG. 6, the resilient member 14 forces the sliding plate 13 into a direction to keep the sliding plate 13 in the open state (X1 direction) as in the case where the sliding plate 13 is in the closed state.

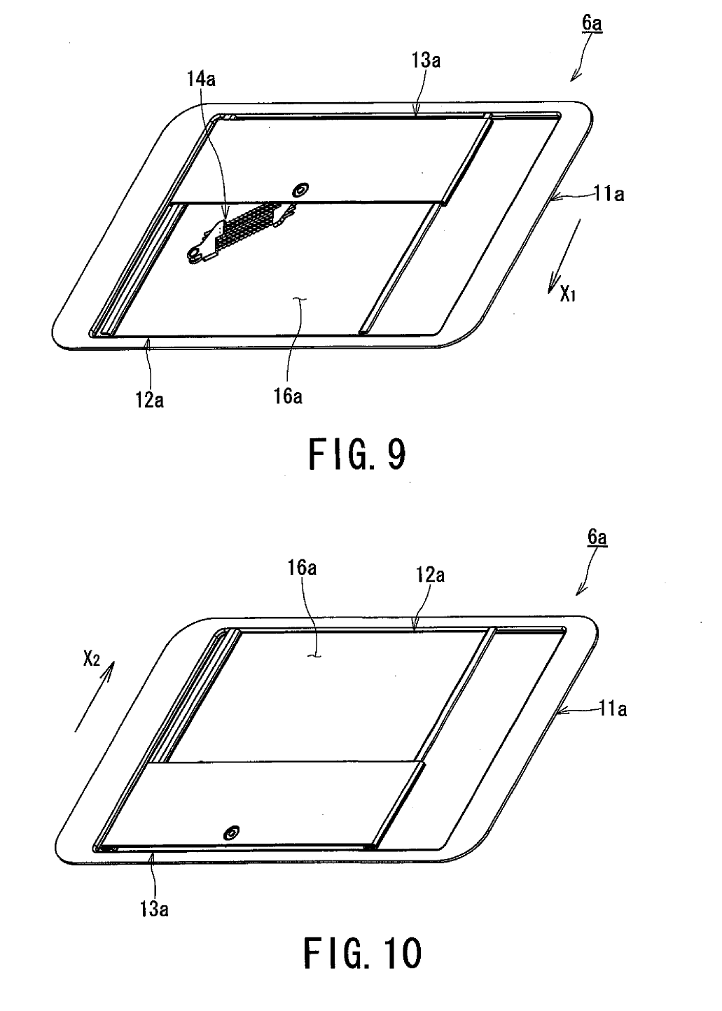

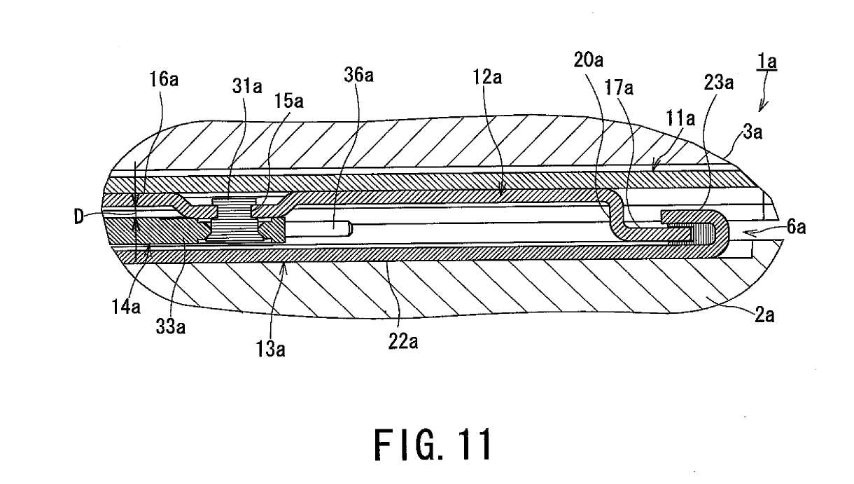

FIG. 9 is a perspective view of a slide mechanism 6a according to a comparative example for comparison with that shown in FIG. 5. FIG. 10 is a perspective view of the slide mechanism 6a for comparison with that shown in FIG. 6. FIG. 11 is an enlarged cross-sectional view of the slide mechanism 6a for comparison with that shown in FIG. 8.

The slide mechanism 6a according to the comparative example shown in FIG. 9 primarily differs from the slide mechanism 6 of the mobile terminal 1 according to the first embodiment in that a rail plate 12a has no opening, and a resilient member 14a is connected to the rail plate 12a and a sliding plate 13a. The other parts of the slide mechanism 6a according to the comparative example shown in FIGS. 9 to 11 have substantially the same configurations as those of the corresponding parts of the slide mechanism 6 of the mobile terminal 1 according to the first embodiment. The parts of the slide mechanism 6a corresponding to those of the mobile terminal 1 according to the first embodiment are denoted by the same reference numerals with a subscript “a”, and redundant descriptions thereof will be omitted.

As shown in FIG. 9, the resilient member 14a of the slide mechanism 6a is connected to a base 16a of the rail plate 12a at one end. The base 16a is exposed to serve as an exterior of an upper housing 3a when a mobile terminal 1a (the slide mechanism 6a) is in the open state as shown in FIG. 10. Therefore, in order to prevent the resilient member 14a from coming into contact with and scratching the base 16a during sliding and thus damaging the appearance of the housing, a certain clearance “D” has to be allowed between the resilient member 14a and the base 16a as shown in FIG. 11. In addition, in order to prevent the resilient member 14a from coming into contact with and scratching an operation key (not shown) on a lower housing 2a or the surface of the lower housing 2a and compromising the appearance thereof, a certain clearance has to be allowed between the resilient member 14a and the lower housing 2a. Such arrangement inevitably leads to an increase in thickness of the slide mechanism 6a as shown in FIG. 11 and hence hinders reduction of the thickness of the mobile terminal 1a.

To the contrary, for the mobile terminal 1 according to the first embodiment, the rail plate 12 has the opening 19, which allows the resilient member 14 to be connected to the base plate 11. The opening 19 allows the holder 33 of the resilient member 14 to be positioned close to the base plate 11, and thus, there is no need to consider the possibility of contacting between the resilient member 14 and the base 16. As a result, the surface of the resilient member 14 facing the upper housing 3 and the surface of the base 16 facing the lower housing 2 can be positioned at substantially the same level in the direction of the stack of the slide mechanism 6. Thus, the thickness of the mobile terminal 1 can be reduced by an amount corresponding to the thickness of the rail plate 12a in the comparative example described above.

Furthermore, in order to prevent the resilient member 14a from coming into contact with the operation key or the surface of the lower housing 2a on which the operation key is provided, it is necessary, for a step 20a provided in the mobile terminal 1a according to the comparative example, to have a certain length (see FIG. 11). However, for the mobile terminal 1 according to the first embodiment in which the rail plate 12 has the opening 19, and the resilient member 14 is connected to the base plate 11, it is not necessary for the step 20 to have a length enough to allow a clearance between the resilient member 14 and the lower housing 2 or the like, and thus, the rail plate 12 can provide a lower profile.

For the mobile terminal 1 according to the first embodiment thus configured, the thickness of the slide mechanism 6 can be appropriately reduced. As a result, the thickness of the mobile terminal 1 having the slide mechanism 6 can be reduced.

Although the mobile terminal 1 according to the first embodiment described above slides along the shorter sides of the housings 2 and 3, the present invention may be applied to a mobile terminal that slides in the longitudinal direction. In addition, the rail plate 12 described above has a rectangular opening 19 formed in the base 16, and the size of the opening 19 can be reduced (or the area of the base 16 can be increased) as far as it does not affect the movement of the resilient member 14. More specifically, the opening 19 has only to cover at least the range of movement of the resilient member 14 in a region 40 of the base plate 11 exposed through the opening 19 when the mobile terminal 1 is opened and the lower housing 2 and the upper housing 3 are positioned as shown in FIG. 3. This is because the user can see the region 40 when the mobile terminal 1 is in the open state, and thus, it is particularly desirable to prevent scratching of the region 40 due to the sliding operation.

### Second Embodiment

A mobile terminal according to a second embodiment of the present invention will be described hereunder with reference to the accompanying drawings.

The appearances of the mobile terminal according to the second embodiment is substantially the same as those according to the first embodiment described with reference to FIGS. 1 to 3, and thus, detailed descriptions thereof with reference to the drawings will be omitted. The same structures or parts as those in the first embodiment are denoted by the same reference numerals, and redundant descriptions thereof will be omitted.

The mobile terminal according to the second embodiment is superior to the mobile terminal 1 according to the first embodiment in ease of assembly.

The assembly process of the slide mechanism 6 according to the first embodiment shown in FIG. 4 involves steps of fitting the sliding plate 13 onto the rail plate 12, connecting the resilient member 14 to the sliding plate 13 and the base plate 11, and then welding the rail plate 12 to the base plate 11, for example. According to this process, in connecting the resilient member 14 to the base plate 11 and the sliding plate 13, the three components, the sliding plate 13, the rail plate 12 and the base plate 11, have to be deliberately positioned, and thus, the productivity may decrease.

According to the second embodiment, the slider mechanism of the mobile terminal can be more simply assembled, and the thickness of the slider mechanism and the mobile terminal can be reduced.

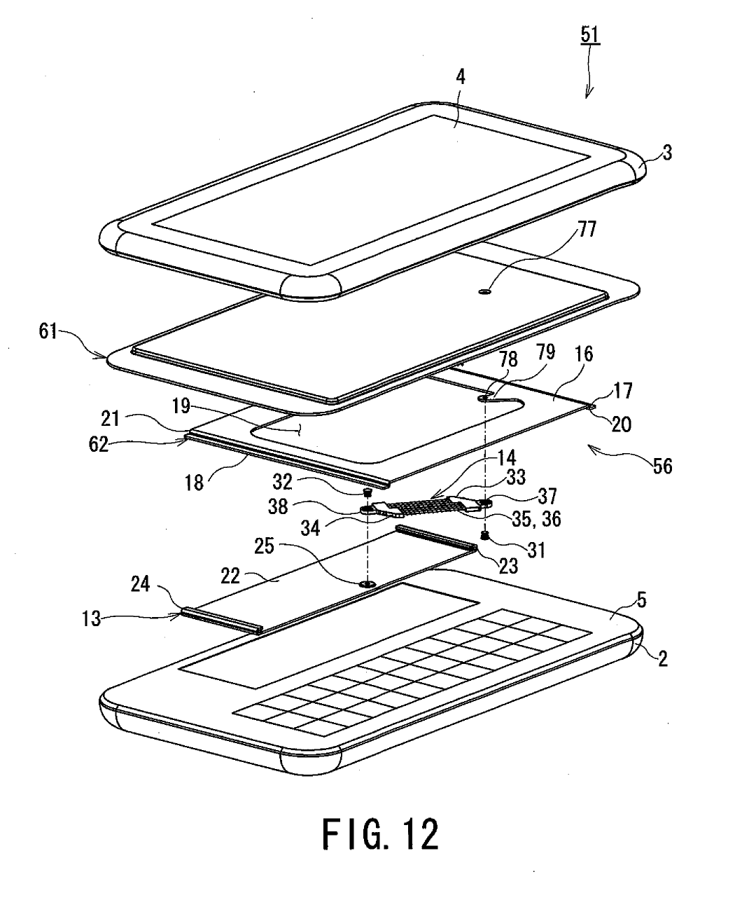

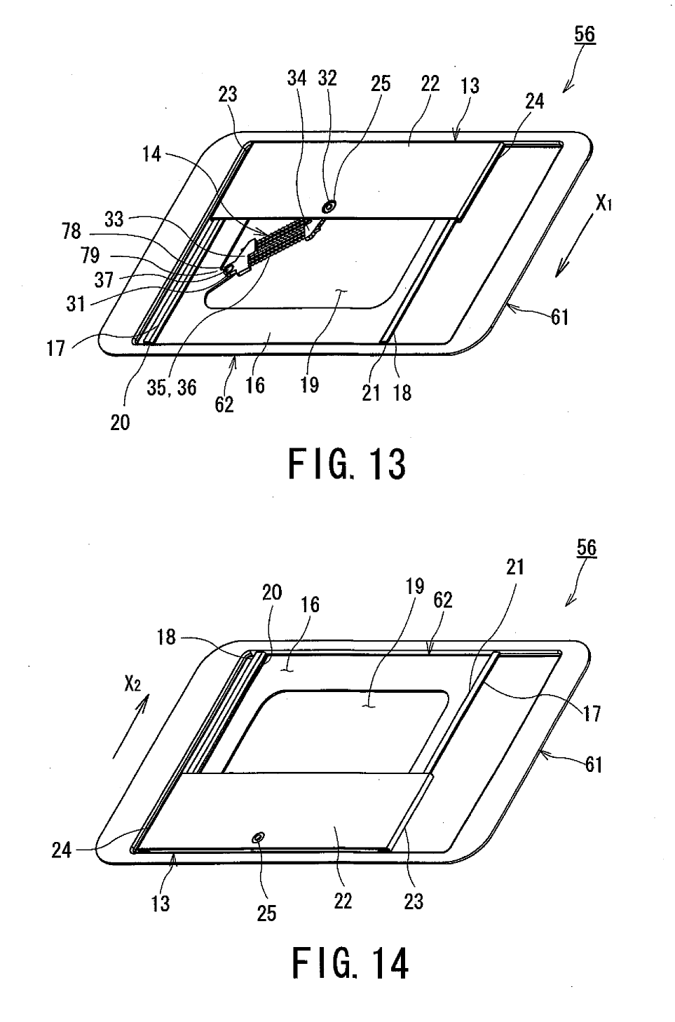

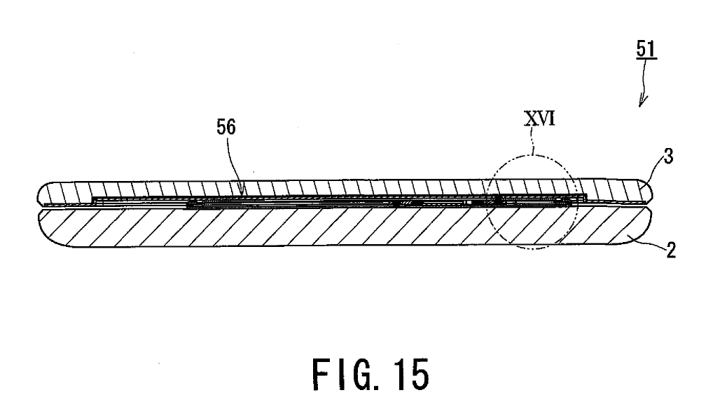

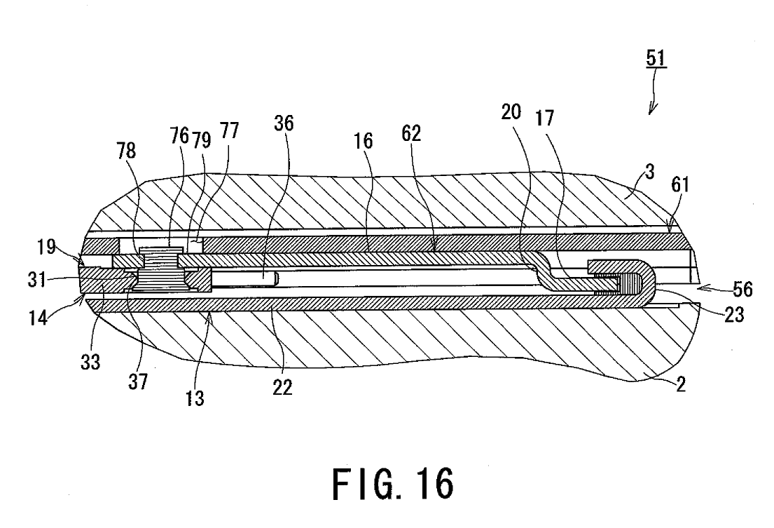

FIG. 12 is an exploded perspective view of a mobile terminal 51 according to the second embodiment. FIG. 13 is a perspective view of a slider mechanism 56 of the mobile terminal 51 in the closed state. FIG. 14 is a perspective view of the slider mechanism 56 of the mobile terminal 51 in the open state. FIG. 15 is a cross-sectional view of the mobile terminal 51 taken along the line XV-XV in FIG. 3. FIG. 16 is an enlarged view of a part of the mobile terminal 51 indicated by an arrow XVI in FIG. 15.

The mobile terminal 51 according to the second embodiment differs from the mobile terminal 1 according to the first embodiment in that the resilient member 14 is connected to a rail plate 62 at one end.

A base plate 61 is formed with a hole 77 serving as a space that houses a pin end 76 of the attachment pin 31 attached to the rail plate 62 (see FIG. 16).

In addition to the rails 17 and 18 and the base 16, the rail plate 62 has a connection member 79 that extends from the base 16 into the opening 19. The connection member 79 is to be connected to one (the other) end of the resilient member 14. The connection member 79 is formed with an attachment hole 78 through which the resilient member 14 is connected to the rail plate 62.

The connection member 79 has a substantially triangular shape in plan view and extends from the base 16 in an inward direction of the rail plate 62, or into the opening 19. The inward direction of the rail plate 62 is a direction from the outer perimeter of the rail plate 62 to the center thereof.

The resilient member 14 is attached to the sliding plate 13 at one end and to the connection member 79 of the rail plate 62 at the other. The attachment pin 31 is inserted into the pin insertion hole 37 of the holder 33 so as to connect one end of the resilient member 14 to the rail plate 62. The attachment pin 32 is inserted into the pin insertion hole 38 of holder 34 to connect the other end of the resilient member 14 to the sliding plate 13. The holders 33 and 34 can pivot about the attachment pins 31 and 32 after connection to the rail plate 62 and the sliding plate 13.

The resilient member 14 is disposed in a space between the rail plate 62 and the sliding plate 13. The resilient member 14 is positioned in such a manner that the range of movement thereof includes a region corresponding to the opening 19.

As a result, the surface of the resilient member 14 facing the upper housing 3 and the surface of the base 16 facing the lower housing 2 can be positioned at substantially the same level in the direction of the stack of the base plate 61, the rail plate 62 and the sliding plate 13.

The mobile terminal 51 has an advantage of ease of assembly in addition to the advantages according to the first embodiment described above. More specifically, the slider mechanism can be assembled by fitting the sliding plate 13 onto the rail plate 62, connecting the resilient member 14 to the sliding plate 13 and the rail plate 62, and then welding the resulting unit to the base plate 61.

According to the second embodiment, the connection member 79 of the rail plate 62 is flush with the base 16. However, depending on the shape of the resilient member 14, the connection member 79 and the base 16 can be positioned at slightly different levels in order to allow a clearance between the resilient member 14 and the base plate 61.

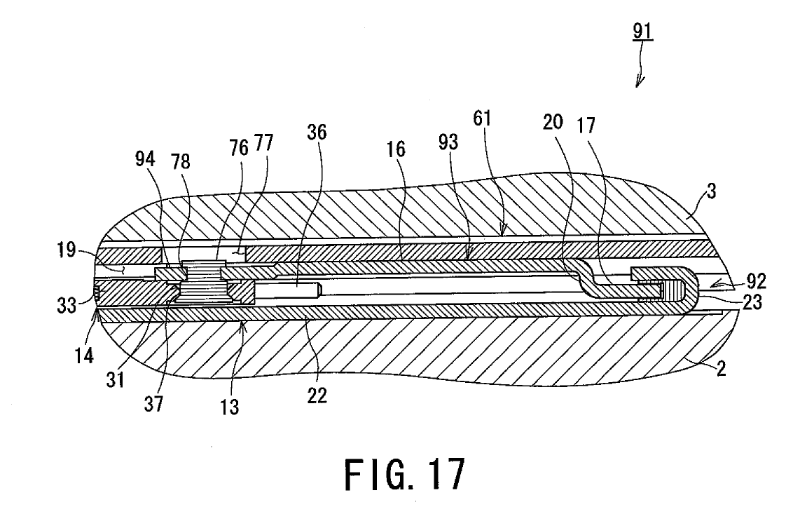

FIG. 17 is an enlarged cross-sectional view of a mobile terminal 91 according to a modification of the second embodiment.

A connection member 94 of a rail plate 93 is slightly lowered toward the sliding plate 13 so that the connection member 94 is positioned to be lower than the base 16 in FIG. 17. In this way, the shape of the connection member 94 can be modified considering the convenience of design of the base plate 61, the rail plate 93 and the sliding plate 13 and the structure of the resilient member 14, and thus, a high design flexibility of a slider mechanism 92 can be maintained.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A mobile terminal comprising:
a first housing;
a second housing disposed on the first housing;
a rail plate that has a pair of rails and a base connecting the rails and is formed with an opening, the rail plate being fixed to a surface of the second housing facing the first housing;
a sliding plate that is fixed to a surface of the first housing facing the second housing and slides on the rails; and
a resilient member that is disposed between the second housing and the sliding plate, the resilient member forcing the sliding plate in a first direction opposite to a second direction until the sliding plate reaches a predetermined position and forcing the sliding plate in the second direction once the sliding plate passes the predetermined position when the sliding plate slides in the second direction,
wherein the resilient member is connected to the sliding plate at one end and to the second housing through the opening at the other end.

2. The mobile terminal according to claim 1, wherein a range of movement of the resilient member includes an interior of the opening.

3. A mobile terminal comprising:
a first housing;
a second housing disposed on the first housing;
a rail plate that has a pair of rails and a base connecting the rails and is formed with an opening, the rail plate being fixed to a surface of the second housing facing the first housing;
a sliding plate that is fixed to a surface of the first housing facing the second housing and slides on the rails; and
a resilient member that is disposed between the second housing and the sliding plate, the resilient member forcing the sliding plate in a first direction opposite to a second direction until the sliding plate reaches a predetermined position and forcing the sliding plate in the second direction once the sliding plate passes the predetermined position when the sliding plate slides in the second direction,
wherein the resilient member is connected to the sliding plate at one end and to the rail plate at the other end.

4. The mobile terminal according to claim 3, wherein a range of movement of the resilient member includes a space above the opening.

5. The mobile terminal according to claim 3, wherein the rail plate further includes a connection member that extends from the base into a region of the opening and is connected to the other end of the resilient member.

6. The mobile terminal according to claim 3 further comprising:
an attachment pin that connects the rail plate and the other end of the resilient member to each other and protrudes from the rail plate toward the second housing at one end; and
a base plate forms a surface of the second housing facing the first housing, which is a surface to which the rail plate is fixed, the base plate having a hole for housing the end of the attachment pin.
